(19) United States
(12) Patent Application Publication
(10) Pub. No.: US 2012/0239474 A1
(43) Pub. Date: Sep. 20, 2012

(54) PREPAID CARD REWARDS

(75) Inventors: Jeffrey Norman Healy, Matthews, NC (US); Kimberly Belle Summerrow, Charlotte, NC (US)

(73) Assignee: BANK OF AMERICA CORPORATION, Charlotte, NC (US)

(21) Appl. No.: 13/157,125

(22) Filed: Jun. 9, 2011

Related U.S. Application Data
(60) Provisional application No. 61/454,379, filed on Mar. 18, 2011.

(51) Int. Cl. G06Q 30/00; G06Q 40/00

(52) U.S. Cl. 705/14.17; 705/41

(57) ABSTRACT

In general terms, embodiments of the present invention relate to a prepaid card account that can accumulate rewards (e.g., points, miles, credits, bonuses, cash back, etc.). For example, in some embodiments, a method is provided that includes: (a) receiving transaction information associated with a transaction, where the transaction includes a transaction amount and involves a prepaid card account; (b) determining that the prepaid card account has a balance; (c) determining, based at least partially on the transaction information, that the transaction amount does not exceed the balance; (d) authorizing the transaction based at least partially on the determining that the transaction amount does not exceed the balance; (e) determining that the transaction is completed; and (f) attributing rewards to the prepaid card account based at least partially on the determining that the transaction is completed. Other embodiments provide a method that includes: (a) receiving funds from a holder of a prepaid card account; (b) increasing a balance of the prepaid card account based at least partially on receiving the funds; and (c) attributing rewards to the prepaid card account based at least partially on the holder loading the prepaid card account.

### CROSS-REFERENCE TO RELATED APPLICATIONS

The present application claims priority to U.S. Provisional Patent Application No. 61/454,379, which was filed on Mar. 18, 2011, is entitled “Prepaid Card Rewards,” and is incorporated by reference herein in its entirety.

### BACKGROUND

Many financial institutions provide their customers with rewards credit card accounts that can accumulate points, miles, and/or other types of rewards. Typically, after being accumulated, these rewards may be redeemed for one or more goods and/or services, such as, for example, gift cards, t-shirts, tickets, statement credits, and/or the like. Because rewards credit card accounts are becoming increasingly popular with customers, financial institutions are focusing on ways in which they can improve and service these types of accounts.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to prepaid card accounts that can accumulate rewards (e.g., points, miles, credits, bonuses, cash back, etc.). More specifically, embodiments relate to methods and apparatuses for attributing rewards to a prepaid card account as a result of the prepaid card account engaging in one or more transactions and/or as a result of the prepaid card account being loaded and/or reloaded with funds. Further, in some embodiments, a user interface (e.g., graphical user interface (GUI), text-based interface, etc.) is provided to a holder of the prepaid card account, where the user interface enables and/or prompts the holder to access an electronic banking account (e.g., online banking account, mobile banking account, text banking account, etc.) associated with the prepaid card account, redeem his rewards, and/or load and/or reload his prepaid card account. Additionally or alternatively, in some embodiments, the user interface includes information associated with the holder's rewards (e.g., rewards balance, redemption history, etc.), information associated with one or more products (e.g., clothing, electronics, gift cards, cash, statement credits, etc.) that the holder can receive in exchange for redeeming his rewards, and/or other information associated with the prepaid card account (e.g., transaction history, balance of prepaid card account, etc.).

In more general terms, some embodiments of the present invention provide a method that includes: (a) receiving transaction information associated with a transaction, where the transaction includes a transaction amount and involves a prepaid card account; (b) determining that the prepaid card account has a balance; (c) determining, based at least partially on the transaction information, that the transaction amount does not exceed the balance; (d) authorizing the transaction based at least partially on the determining that the transaction amount does not exceed the balance; (e) determining that the transaction is completed (e.g., finalized, cleared, posted, authorized, etc.); and (f) attributing rewards to the prepaid card account based at least partially on the determining that the transaction is completed.

In other embodiments, an apparatus is provided that includes: (a) a communication interface configured to receive transaction information associated with a transaction, where the transaction has a transaction amount and involves a prepaid card account; and (b) a processor operatively connected to the communication interface and configured to: (i) determine that the balance of the prepaid card account is greater than the transaction amount; (ii) authorize the transaction based at least partially on determining that the balance is greater than the transaction amount; and (iii) attribute rewards to the prepaid card account for engaging in the transaction.

In still other embodiments, a computer program product having a non-transitory computer-readable medium is provided, where the non-transitory computer-readable medium includes one or more computer-executable program code portions that, when executed by a computer, cause the computer to: (a) receive transaction information associated with a transaction, where the transaction has a transaction amount and involves a prepaid card account; (b) determine, based at least partially on the transaction information, that the transaction amount does not exceed the balance of the prepaid card account; (c) authorize the transaction based at least partially on the computer determining that the transaction amount does not exceed the balance; and (d) attribute rewards to the prepaid card account based at least partially on the prepaid card account engaging in the transaction.

In other embodiments, a method is provided that includes: (a) receiving funds from a holder of a prepaid card account for loading the prepaid card account; (b) increasing a balance of the prepaid card account based at least partially on the receiving the funds (e.g., increasing the balance by the amount of the funds); and (c) attributing rewards to the prepaid card account based at least partially on the holder loading the prepaid card account.

### BRIEF DESCRIPTION OF THE DRAWINGS

Having thus described some embodiments of the present invention in general terms, reference will now be made to the accompanying drawings, where:

FIG. 1 is a flow diagram illustrating a general process flow for attributing rewards to a prepaid card account as a result of the prepaid card account engaging in a transaction, in accordance with an embodiment of the present invention;

FIG. 2 is a flow diagram illustrating a general process flow for attributing rewards to a prepaid card account as a result of a holder of the prepaid card account loading or reloading funds onto that prepaid card account, in accordance with an embodiment of the present invention;

FIG. 3 is a flow diagram illustrating a more-detailed process flow for attributing rewards to a prepaid card account, in accordance with an embodiment of the present invention;

FIG. 4 is a block diagram illustrating technical components of a system for providing one or more prepaid cards, prepaid card accounts, and/or attributing rewards to prepaid card accounts, in accordance with an embodiment of the present invention; and

FIG. 5 is a mixed block and flow diagram of a system for attributing rewards to a prepaid debit card account, in accordance with an embodiment of the present invention.

### DETAILED DESCRIPTION OF EMBODIMENTS OF THE PRESENT INVENTION

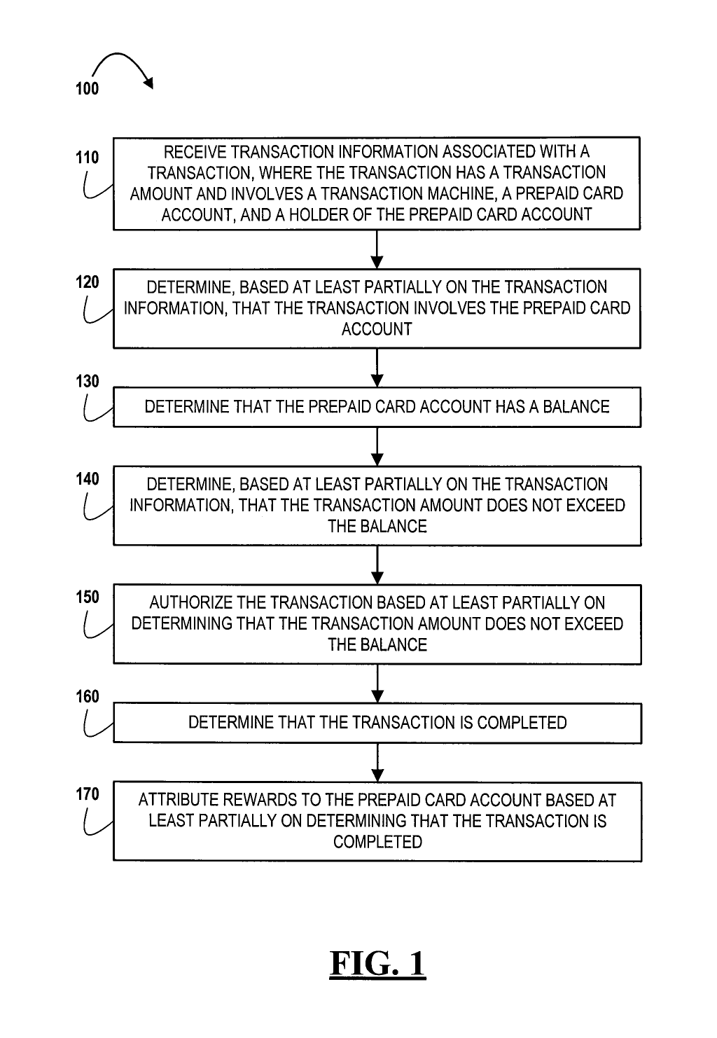

Referring to FIG. 1, a general process flow 100 is provided for attributing rewards to a prepaid card account as a result of the prepaid card account engaging in a transaction, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a transaction, where the transaction has a transaction amount and involves a transaction machine, a prepaid card account, and a holder of the prepaid card account. As represented by block 120, the apparatus is also configured to determine, based at least partially on the transaction information, that the transaction involves the prepaid card account. In addition, as represented by block 130, the apparatus is configured to determine that the prepaid card account has a balance. As represented by block 140, the apparatus is further configured to determine, based at least partially on the transaction information, that the transaction amount does not exceed the balance. Additionally, as represented by block 150, the apparatus is configured to authorize the transaction based at least partially on determining that the transaction amount does not exceed the balance. As represented by block 160, the apparatus is further configured to determine that the transaction is completed. Further, as represented by block 170, the apparatus is configured to attribute rewards (i.e., one or more rewards) to the prepaid card account based at least partially determining that the transaction is completed (and/or based at least partially on the holder engaging in the transaction and/or spending funds on the prepaid card account).

It will be understood that the term “determine,” as used herein, is meant to have its one or more ordinary meanings (i.e., its ordinary dictionary definition(s)), but that in other embodiments, the term “determine” is meant to have one or more ordinary meanings of one or more of the following terms: decide, conclude, verify, ascertain, find, discover, learn, calculate, observe, read, and/or the like. In addition, in some embodiments, the phrase “based at least partially on” is meant to have one or more of its ordinary meanings, but in other embodiments, the phrase “based at least partially on” is meant to have one or more ordinary meanings of one or more of the following terms and/or phrases: in response to, because of, after, as a result of, and/or the like. Further, for simplicity, the phrase “prepaid card account” is meant to include the prepaid card account and/or the prepaid card associated with that prepaid card account, unless explicitly stated otherwise.

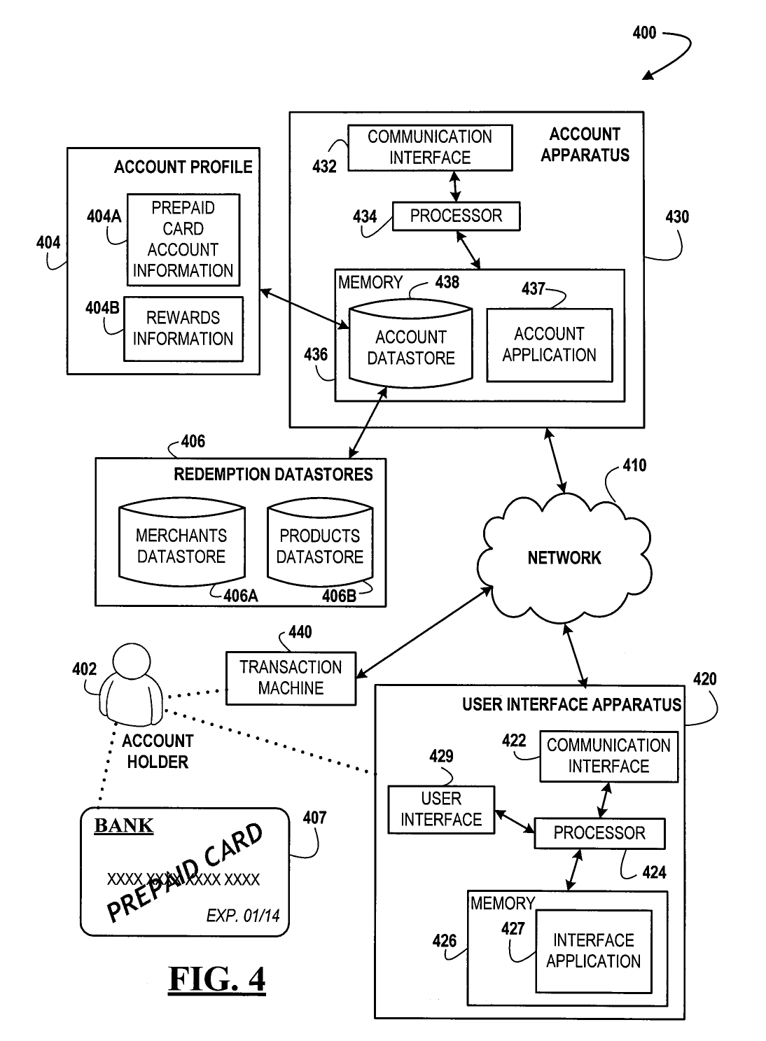

It will also be understood that the apparatus having the process flow 100 can include one or more separate and/or different apparatuses. For example, in some embodiments, one apparatus (e.g., the transaction machine 440 described in connection with FIG. 4, etc.) is configured to perform the portions of the process flow 100 represented by blocks 110-150, and a second apparatus (e.g., the account apparatus 430) is configured to perform the portions represented by blocks 160 and 170. As still another example, in some embodiments, a single apparatus (e.g., the account apparatus 430) is configured to perform each and every portion of the process flow 100.

Regarding block 110, the phrase “transaction machine,” as used herein, generally refers to an interactive computer terminal that is configured to initiate, perform, complete, and/or facilitate one or more financial transactions. Examples of transaction machines include, but are not limited to, automated teller machines (ATMs), POS devices (e.g., merchant terminals, etc.), self-service machines (e.g., vending machine, self-checkout machine, parking meter, etc.), kiosks (e.g., an Internet kiosk, ticketing kiosk, bill pay kiosk, etc.), mobile phones (e.g., feature phone, smart phone, iPhone®, etc.), gaming devices (e.g., Nintendo Wii®, PlayStation Portable®, etc.), computers (e.g., personal computers, tablet computers, laptop computers, etc.), personal digital assistants (PDAs), and/or the like.

In some embodiments, the transaction machine referred to in block 110 is located in a public place and is available for public use (e.g., on a street corner, on the exterior wall of a banking center, at a public rest stop, etc.). In other embodiments, the transaction machine is additionally or alternatively located in a place of business and available for public and/or business customer use (e.g., in a retail store, post office, banking center, grocery store, etc.). In accordance with some embodiments, the transaction machine is not owned by the user of the transaction machine and/or by the holder of the prepaid card account referred to in block 110. However, in other embodiments, the transaction machine is located in a private place, is available for private use, and/or is owned by the user of the transaction machine (e.g., the holder referred to in block 110).

Further regarding block 110, the transaction involving the holder and the transaction machine can include any number and/or type of transaction(s) involving a transaction machine. For example, in some embodiments, the transaction includes one or more of the following: purchasing, renting, selling, and/or leasing goods and/or services (e.g., groceries, stamps, tickets, DVDs, vending machine items, etc.); withdrawing cash (where possible); making payments to creditors (e.g., paying monthly bills; paying federal, state, and/or local taxes and/or bills; etc.); sending remittances; transferring balances from one account to another account; donating to charities; and/or the like.

Still referring to block 110, the prepaid card account generally refers to a deposit account that is associated with a prepaid card, can be loaded and/or reloaded with funds, and cannot be overdrawn. In some embodiments, the prepaid card account may be used to engage in one or more transactions but only if those one or more transactions are “paid for” in advance. Additionally or alternatively, in some embodiments, the prepaid card account is not a conventional checking account, savings account, credit card account, or the like. Further, in some embodiments, the prepaid card account is not linked or otherwise tied to a deposit account, credit account, master account, sub-account, or the like for purposes of covering overdrafts and/or over limit amounts. This is not to say, however, that the prepaid card account cannot be loaded and/or reloaded with funds from one or more deposit and/or credit accounts. For example, in some embodiments, the holder of the prepaid card account may use the holder's checking account to load the prepaid card account with funds; however, if the prepaid card account attempts to engage in an overdraft transaction, the checking account cannot be used to cover the overdraft amount. In addition, in such embodiments, the overdraft transaction will be declined because the account involved in the transaction is a prepaid card account.

Further regarding block 110, in some embodiments, the prepaid card is not a gift card or stored-value card (SVC), and the prepaid card account is not a gift card account or SVC account. For example, as understood herein, an SVC refers to a card that is configured such that balance information associated with the SVC can be written and/or rewritten to the SVC (e.g., to a magnetic stripe disposed on the SVC) after one or more transactions. For example, if a $50 SVC is used to purchase a $30 product, a POS device that processes the SVC transaction may write information to the SVC indicating that the SVC has a $20 balance remaining as a result of the $30 transaction. In contrast, in some embodiments, the prepaid card only stores account information (e.g., routing and/or account numbers, PINS, identity of holder, identity of financial institution that maintains the prepaid card, etc.) on the card (e.g., in a magnetic stripe and/or some other computer-readable medium disposed on the card), and balance information (e.g., balance amount, transaction history, etc.) and/or rewards information (e.g., rewards balance, redemption history, etc.) associated with the prepaid card account is not stored on the card. Instead, in such embodiments, the balance information is stored on a back-end datastore at the financial institution that issued the prepaid card and/or that maintains the prepaid card account. For example, in some embodiments, the balance information associated with the prepaid card account is stored in an account profile associated with the prepaid card account and/or in an electronic banking account (e.g., online banking account, mobile banking account, text banking account, etc.) associated with the prepaid card account. Further, in some embodiments, the prepaid card is different from a gift card or SVC because the prepaid card (and/or associated prepaid card account) is issued in the name of an individual account holder (e.g., the holder referred to in block 110), whereas the gift card and SVC are not (e.g., the holder of the gift card or SVC is anonymous). That said, in some embodiments, the prepaid card may be embodied as a gift card, and the prepaid card account may be embodied as a gift card account. Additionally or alternatively, in some embodiments, the prepaid card may be embodied as an SVC, and the prepaid card account may be embodied as an SVC account

Also, it will be understood that the prepaid card account can be loaded and/or reloaded with funds through one or more channels. Exemplary channels include ATMs, kiosks (e.g., retail store kiosks, ticketing kiosks, etc.), electronic banking accounts, personal computers, mobile phones, direct deposit, mobile/remote deposit, banking centers, call centers, and/or the like. Additionally or alternatively, in some embodiments, the prepaid card account is configured such that funds can be moved off of the prepaid card account after the prepaid card account is loaded and/or reloaded with those funds. For example, in some embodiments, the holder of the prepaid card account may load the prepaid card account with $50 from his checking account on Monday, but then a day later, the holder may transfer $25 from his prepaid card account back to his checking account.

It will be understood that the use of the different terms “load” and “reload” herein is not meant to imply that those terms refer to different kinds of actions. Instead, these different terms are typically used herein to imply a particular order of events in a given context. Specifically, the term “reload” is typically used only to distinguish a later loading of funds from an earlier loading of funds. This is not to say, however, that a “reloading” of the prepaid card account cannot be called or understood as a “loading” of the prepaid card account. For example, a holder may “load” the prepaid card account with funds immediately after the account is opened (i.e., when the account is loaded with funds for the very first time), but the holder may also “load” the prepaid card account with second funds sometime thereafter. It will be understood that, in this example, this second “loading” may be referred to as a “loading” or “reloading,” even though, for simplicity, it is likely to be referred to as a “reloading” herein.

Also, in some embodiments, the prepaid card associated with the prepaid card account may be purchased at a retailer, even though the prepaid card account itself is maintained by a financial institution. In some of these embodiments, the prepaid card account is preloaded with funds. For example, in some embodiments, a financial institution customer may purchase a $50 prepaid debit card at a retailer for $50 plus a small service charge (e.g., $4.95). In some of these embodiments, although the prepaid debit card was purchased at the retailer, the prepaid debit card account must be activated and/or registered at the financial institution that maintains the prepaid debit card account. In some of these embodiments, the prepaid debit card account must be activated and/or registered with the financial institution before the prepaid debit card account can be used to engage in transactions. In other embodiments, however, the financial institution that maintains the prepaid card account may provide and/or issue the prepaid card directly to the holder (e.g., via mail, at a banking center, etc.). Also, in some embodiments, a personal identification number (PIN) (e.g., three or four-digit secret number) may be associated with the prepaid card account, and in some embodiments, the prepaid card account cannot engage in transactions unless and/or until the correct PIN is provided to the transaction machine and/or the apparatus having the process flow 100.

The transaction information referred to in block 110 can be any information that identifies, defines, describes, and/or is otherwise associated with the transaction. Exemplary transaction information includes, but is not limited to, the party(ies) involved in the transaction, the date and/or time of the transaction, the posting date of the transaction, the account(s) involved in the transaction, the transaction amount(s) associated with the transaction, the good(s) and/or service(s) involved in the transaction (e.g., product names, stock keeping unit (SKU) information, universal product code (UPC) information, etc.), a description of the transaction (which, itself, can include any transaction information, e.g., the description may describe the transaction status, the goods and/or services involved in the transaction, etc.), and/or the like.

The transaction information can also include any information that defines and/or identifies the type of the transaction. As understood herein, the transaction type of a transaction may be defined, at least in part, by the one or more goods and/or services involved in the transaction, the one or more types of accounts involved in the transaction (e.g., prepaid card account, etc.), the one or more parties involved in the transaction (e.g., account holder, bank, teller, merchant, counterparty, etc.), when the transaction was initiated (e.g., time of day, day of week, etc.), and/or the like. In some embodiments, the transaction type is defined, at least in part, by the one or more channels through which the transaction is conducted, such as, for example, a POS device (e.g., merchant terminal, etc.), ATM, teller terminal, electronic banking account (e.g., online banking account, mobile banking account, SMS banking account, etc.), personal computer, kiosk, call center, and/or the like. Additionally or alternatively, in some embodiments, the transaction type is defined, at least in part, by the one or more instruments and/or methods used to conduct the transaction, such as, for example, prepaid cards, wire transfers, online bill pay, automated clearing house (ACH), contactless payments, near field communication (NFC) interface payments, and/or the like.

In some embodiments, the transaction information additionally or alternatively identifies and/or describes one or more merchant category codes (MCCs) associated with the transaction. As used herein, the phrase “merchant category code” generally refers to a number assigned to a merchant by a financial institution, where the number is used to classify the merchant by the type of goods and/or services the merchant provides. In some embodiments, the merchant category code is a four digit number assigned by VISA®, MasterCard®, and/or some other credit card provider (which, in some embodiments, is a bank). Exemplary merchant category codes include “5814” for fast food restaurants, “5933” for pawn shops, “8062” for hospitals, “5411” for grocery supermarkets, and “3501” for Holiday Inn Express®. A merchant category code may generally refer to the goods and/or services provided by a merchant (e.g., hospital, fast food restaurant, etc.) and/or may specifically identify the name of an individual merchant (e.g., Holiday Inn Express®, Mirage Hotel & Casino®, etc.). In other words, individual industries and/or individual merchants can have their own merchant category codes. In some embodiments, a transaction type may be defined, at least in part, by one or more merchant category codes associated with the transaction.

It will be understood that any given transaction may have more than one transaction type. For example, in accordance with some embodiments, a transaction involving a transfer of funds from a checking account to a prepaid card account, where the transaction is initiated via online banking, may be defined as a funds transfer transaction, an checking account transaction, a prepaid card account transaction, and/or an online banking transaction. As still another example, in accordance with some embodiments, a purchase transaction involving a POS device maintained by a grocery store and a prepaid card may be defined as a purchase transaction, a POS device transaction, a grocery store transaction, a prepaid card transaction, and/or a “MCC 5411” transaction.

Also regarding block 110, the apparatus having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, prepaid card transactions, ATM transactions, POS device transactions, and/or one or more other types of transactions that involve one or more accounts maintained by the financial institution.

In some embodiments, the apparatus having the process flow 100 is configured to receive the transaction information based at least partially on the holder presenting account information (e.g., prepaid card account number, prepaid card number, credentials, PIN, expiration date of prepaid card, card verification value (CVV) on the prepaid card, name(s) of holder(s) of the prepaid card account, etc.) at the transaction machine. For example, in some embodiments, where the transaction machine is embodied as a POS device, the holder presents account information at the POS device by swiping a prepaid card through a POS device. As another example, in some embodiments, the holder presents account information at the transaction machine by inputting account information into the transaction machine via a user interface associated with the transaction machine. As still another example, in some embodiments, the holder presents account information at the transaction machine by “tapping” a NFC-enabled prepaid card at an NFC-enabled transaction machine. For example, in some of these embodiments, the prepaid card includes a near field communication (NFC) interface (e.g., RFID tag, Bluetooth®, smart card, IR/radio transmitter/receiver, etc.), and the transaction machine includes an NFC interface, such that the holder may wirelessly and/or contactlessly communicate account information from the prepaid card to the transaction machine by holding the NFC interface of the prepaid card within approximately four inches of the NFC interface of the transaction machine.

Additionally or alternatively, the apparatus can be configured to receive the transaction information directly or indirectly from the source of the transaction. For example, in some embodiments, the apparatus is located remotely from the transaction machine but is operatively connected to the transaction machine via a network. As another example, the apparatus may include, be included in, and/or be embodied as a transaction machine. For example, in some embodiments, the apparatus having the process flow 100 includes the transaction machine referred to in block 110. As another example, in some embodiments, the apparatus having the process flow 100 is embodied as a transaction machine separate from, and/or different than, the transaction machine mentioned in the process flow 100.

Further regarding block 110, in some embodiments, the apparatus having the process flow 100 is controlled, serviced, owned, operated, managed, and/or otherwise maintained (sometimes collectively referred to herein as “maintained” for simplicity) by a financial institution (e.g., bank, credit card provider, mortgage lender, student loan company, etc.). In some embodiments, the financial institution that maintains the apparatus having the process flow 100 is the same financial institution that maintains the prepaid card account referred to in block 110.

Regarding block 120, the apparatus can be configured to determine that the transaction involves the prepaid card account in any way. In some embodiments, this determination is based at least partially on the transaction information received. For example, in some embodiments, the transaction information includes an account number associated with the prepaid card and/or the prepaid card account, such that the apparatus having the process flow 100 can use that account number to identify the account and determine the type of account (i.e., that the account is a prepaid card account). In some embodiments, the identity and/or type of the account may be apparent based on the specific account number associated with the account (e.g., where the middle four digits of an account number is a predetermined number (e.g., “4351”) if the account is a prepaid card account).

Regarding blocks 130-150, the term “balance” may refer to an available balance, total balance, balance associated with a predetermined budget category for the prepaid card account, and/or the like. Regarding block 160, the term “completed” may refer to the transaction being finalized, cleared, posted, authorized, and/or completed. In some embodiments, the apparatus determines that the transaction is completed by determining that a balance associated with the prepaid card account is decreased based at least partially on the transaction amount (e.g., decreased by the transaction amount). It will be understood that, in some embodiments, the apparatus is configured to determine that the transaction is completed well after the apparatus authorizes the transaction (e.g., one or more hours, days, weeks, and/or months after the apparatus authorizes the transaction).

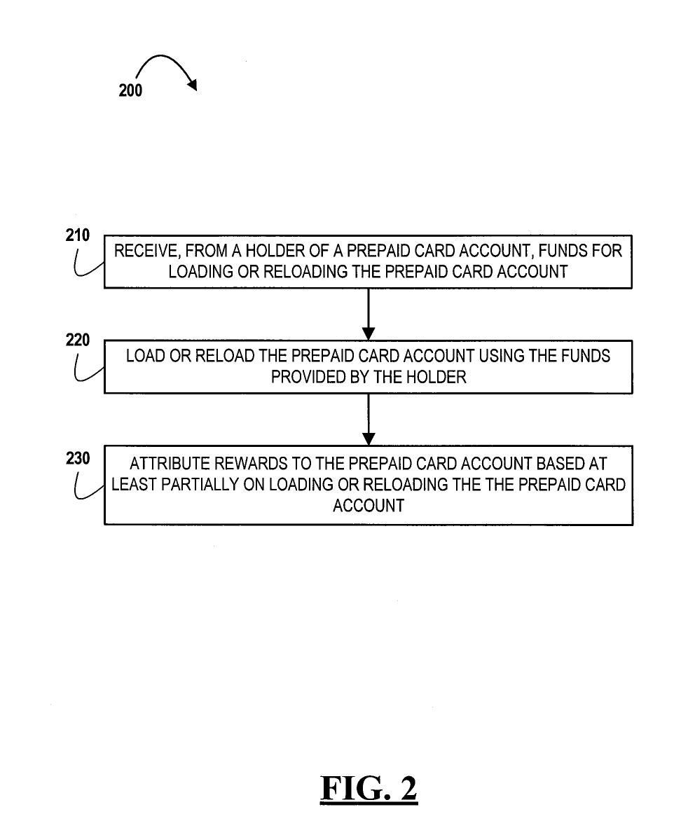

Regarding block 170, in some embodiments, the prepaid card account is capable of earning, accruing, acquiring, collecting, compiling, aggregating, incurring, and/or otherwise accumulating rewards. For example, in the embodiment represented by FIG. 1, the prepaid card account accumulates rewards based at least partially on the prepaid card account engaging in one or more transactions. As another example, in the embodiment represented by FIG. 2, the prepaid card account accumulates rewards based at least partially on a holder of the prepaid card account loading and/or reloading funds onto the prepaid card account. Exemplary rewards include, but are not limited to, one or more points, miles, credits, bonuses, and/or cash back. It will be understood that the rewards accumulated by the prepaid card account can be redeemed for one or more products (e.g., goods, services, merchandise, etc.). Exemplary products include, but are not limited to, clothing, gift cards, electronics, tickets, statement/account credits, cash, and/or the like.

In some embodiments, the prepaid card account accumulates merchant-specific rewards and/or its rewards can be redeemed for merchant-specific products. For example, in some embodiments, the prepaid card is associated with a merchant (e.g., co-branded by a merchant and a financial institution), where the merchant has partnered with the financial institution to provide merchant-specific rewards and/or products to the financial institution's customers. As a specific example, in some embodiments, the prepaid card is embodied as a Bass Pro Shops®-branded prepaid debit card that can accumulate “Bass Pro Shops® points,” which can be redeemed (and/or are only redeemable) for one or more products branded by, or sold at, Bass Pro Shops® stores.

Further regarding block 170, the apparatus can be configured to assign, ascribe, credit, and/or otherwise attribute one or more rewards to the prepaid card account at any time. Additionally or alternatively, the apparatus can determine, at any time, whether the prepaid card account has engaged in a transaction that earns rewards. For example, in some embodiments, the apparatus is configured to attribute rewards (and/or to determine whether to attribute rewards) to the prepaid card account at the end of every month and/or at the end of one or more (or every) statement cycle. As another example, in some embodiments, the apparatus is configured to attribute rewards (and/or to determine whether to attribute rewards) to the prepaid card account at the end of each business day. However, in other embodiments, the apparatus is configured to attribute rewards (and/or to determine whether to attribute rewards) in substantially real time, i.e., moments, seconds, and/or minutes after the account engages in a transaction. As understood herein, the phrase “attributing rewards to the prepaid card account” may include attributing rewards to the prepaid card account, the prepaid card, a holder of the prepaid card account (e.g., the holder referred to in block 110), and/or one or more other accounts held by the holder.

It will be understood that the apparatus having the process flow 100 can be configured to perform any of the portions of the process flow 100 represented by blocks 110-170 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus having the process flow 100 is configured such that the apparatus determining that the transaction is completed (the triggering event) automatically and immediately or nearly immediately (e.g., within 1-30 seconds, etc.) triggers the apparatus to attribute rewards to the prepaid card account (the triggered action(s)). In some embodiments, the apparatus is additionally or alternatively configured to authorize the transaction (triggered action) automatically and immediately or nearly immediately after determining that the transaction amount does not exceed the balance of the prepaid card account (triggering event).

In accordance with some embodiments, the apparatus having the process flow 100 is configured to automatically perform one or more of the portions of the process flow 100 represented by blocks 110-170, whereas in other embodiments, one or more of the portions of the process flow 100 represented by blocks 110-170 require and/or involve human intervention (e.g., a user operating the apparatus configured to perform the process flow 100, etc.). In addition, it will be understood that, in some embodiments, the apparatus configured to perform the process flow 100 (and/or a user thereof) is configured to perform one or more portions (or combinations of portions) of the process flow 100, from start to finish, within moments, seconds, and/or minutes (e.g., within approximately 1-45 seconds from start to finish, etc.).

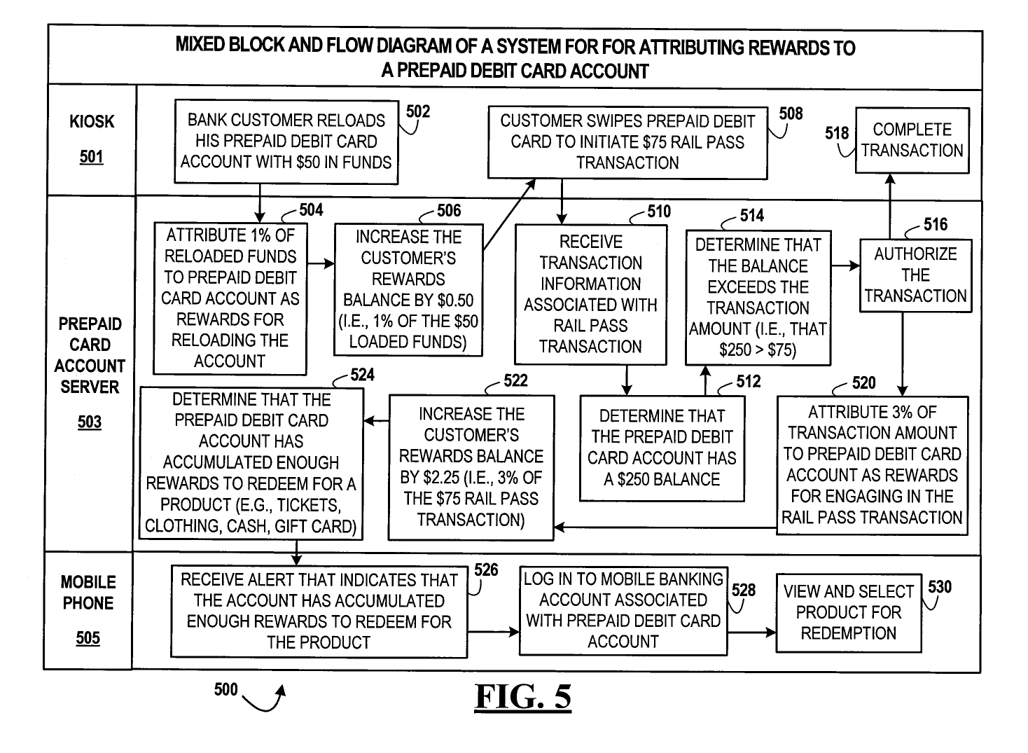

Also, it will be understood that the apparatus having the process flow 100 can be configured to perform one or more portions of any embodiment described and/or contemplated herein, such as, for example, one or more portions of the process flow 200 described herein, one or more portions of the process flow 300 described herein, and/or one or more portions of the process flow described in connection with FIG. 5. Also, the number, order, and/or content of the portions of the process flow 100 are exemplary and may vary. For example, in some alternative embodiments, the apparatus having the process flow 100 is also configured to load and/or reload the prepaid card account with funds (e.g., provided by the holder). As another example, in some alternative embodiments, the apparatus is configured to update information (e.g., transaction history, balance information, etc.) associated with the prepaid card account (e.g., stored in an account profile and/or datastore) based at least partially on the transaction. Further, in some alternative embodiments, the apparatus is configured to enable the holder to open the prepaid card account, manage the prepaid card account, and/or to view information associated with the prepaid card account (e.g., transaction history, balance, rewards balance, etc.).

As still another example, in some alternative embodiments, the apparatus having the process flow 100 is configured to present a user interface (e.g., graphical user interface (GUI), text-based user interface, etc.) to the holder of the prepaid card account, where the user interface enables and/or prompts the holder to select one or more products to receive in exchange for redeeming one or more rewards associated with the prepaid card account. As another example, in some alternative embodiments, the apparatus having the process flow 100 (and/or the transaction machine) is configured to identify and/or authenticate (e.g., confirm the identity of) the holder as a condition of processing the transaction, attributing the rewards to the prepaid card account, and/or the like. In some embodiments, the apparatus is configured to authenticate the holder based at least partially on a prepaid card, account number, username, password, PIN, biometric information, bar code, and/or other credential the holder inserts, provides, and/or presents to the apparatus having the process flow 100 (and/or to the transaction machine).

Further regarding the process flow 100, in some embodiments, the prepaid card account may be configured such that the prepaid card account can accumulate rewards only if one or more predetermined spending conditions are met. For example, in some embodiments, the prepaid card account may accumulate rewards only if the transaction amount exceeds a predetermined amount (e.g., $15, $100, etc.). As another example, in some embodiments, the prepaid card account may accumulate a higher amount of rewards (or only accumulate rewards) if the transaction involves a merchant from a list of predetermined merchants (e.g., restaurant merchants, cruise line merchants, etc.) and/or involves a merchant associated with a merchant category code from a list of predetermined merchant category codes (e.g., 5812 for restaurants, 4411 for cruise lines, etc.).

Referring now to FIG. 2, a general process flow 200 is provided for attributing rewards to a prepaid card account as a result of a holder of the prepaid card account loading and/or reloading funds onto that prepaid card account, in accordance with an embodiment of the present invention. In some embodiments, the process flow 200 is performed by an apparatus (i.e., one or more apparatuses) having hardware and/or software configured to perform one or more portions of the process flow 200. Further, in some embodiments, the apparatus having the process flow 200 is also configured to perform the process flow 100 and/or any other process flow described and/or contemplated herein. As shown in FIG. 2, the apparatus having the process flow 200 is configured to receive, from a holder of a prepaid card account, funds for loading or reloading the prepaid card account, as represented by block 210 of the process flow 200. As represented by block 220, the apparatus is also configured to load or reload the prepaid card account using the funds provided by the holder. In addition, as represented by block 230, the apparatus is further configured to attribute rewards to the prepaid card account based at least partially on loading or reloading the prepaid card account.

Regarding the process flow 200, in some embodiments, the prepaid card account may be configured such that the prepaid card account can accumulate rewards only if one or more predetermined loading and/or reloading conditions are met. For example, in some embodiments, the prepaid card account may accumulate rewards only if a direct deposit of funds is deposited into the prepaid card account at least twice a month (e.g., to correspond to semi-monthly paychecks). In some of these embodiments, rewards will not be attributed unless both of the following conditions are met: (a) the funds must be received as a direct deposit; and (b) the account must be loaded with funds via direct deposit at least twice a month. As another example, in some embodiments, the prepaid card account may accumulate rewards only if the amount of funds loaded onto the prepaid card account exceeds a predetermined amount (e.g., $50, $200). Also, it will be understood that, in some embodiments, the apparatus is configured to attribute rewards to the prepaid card account either immediately (e.g., moments, seconds, minutes) or well after (e.g., hours, days, weeks, months) the apparatus loads or reloads the prepaid card account.

Of course, it will be understood that the embodiment illustrated in FIG. 2 is merely exemplary and that other embodiments may vary without departing from the scope and spirit of the present invention. In addition, the apparatus having the process flow 200 can be configured to perform one or more portions of the process flow 200 in real time, in substantially real time, and/or at one or more predetermined times. The apparatus having the process flow 200 may be configured to perform any of the portions of the process flow 200 represented by blocks 210-230 upon or after one or more triggering events (which, in some embodiments, is the performance of one or more of the other portions of the process flow 200). In addition, in some embodiments, the apparatus having the process flow 200 (and/or a user thereof) is configured to perform one or more portions (or combinations of portions) of the process flow 200, from start to finish, within moments, seconds, and/or minutes (e.g., within approximately 1-15 minutes, etc.).

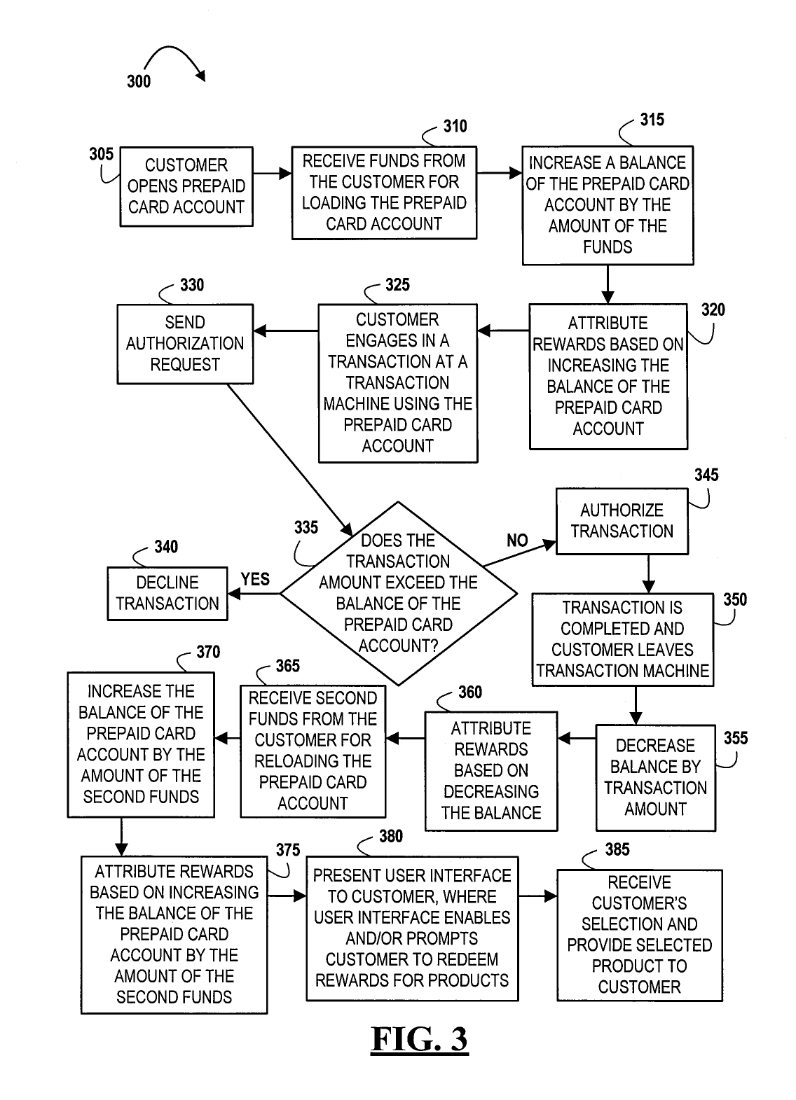

Referring now to FIG. 3, a more-detailed process flow 300 for attributing rewards to a prepaid card account, in accordance with an embodiment of the present invention. It will be understood that the process flow 300 illustrated in FIG. 3 represents an example embodiment of the process flow 100 and/or process flow 200 described in connection with FIGS. 1 and/or 2. In some embodiments, one or more portions of the process flow 300 are performed by an apparatus having hardware and/or software configured to perform one or more portions of the process flow 300. In this example embodiment, the apparatus having the process flow 300 is maintained by a bank for the benefit of its customers. In addition, the customer referred to in the process flow 300 is a customer of the bank. Further in this example embodiment, the prepaid card account referred to in the process flow 300 is an account held by the customer and maintained by the bank.

As represented by block 305, the bank customer opens a prepaid card account. For example, in some embodiments, the customer opening the prepaid card account includes purchasing a prepaid card associated with the prepaid card account at a retail store. As another example, the customer opening the prepaid card account includes registering and/or activating the prepaid card and/or prepaid card account with the financial institution that maintains the prepaid card account. As still another example, in some embodiments, the customer opening the prepaid card account includes signing up for the prepaid card account via, for example, an online banking account and/or a financial institution website. As yet another example, in some embodiments, the customer opening the prepaid card account includes being issued, in the customer's name, a prepaid card associated with the prepaid card account.

As represented by block 310, the apparatus having the process flow 300 receives funds from the customer for loading the prepaid card account. As represented by block 315, the apparatus increases a balance of the prepaid card by the amount of the funds. As represented by block 320, the apparatus also attributes rewards to the prepaid card account based at least partially on increasing the balance of the prepaid card account. In other words, the apparatus attributes rewards based at least partially on the customer loading funds onto the prepaid card account. In some embodiments, the prepaid card account does not accumulate these rewards immediately after the funds have been loaded onto the prepaid card account (e.g., the rewards are attributed to the account at the end of the month in which the loading occurred).

Sometime after the prepaid card account has been loaded with funds, the customer engages in a transaction at a transaction machine (e.g., POS device, ATM, kiosk, etc.) using the prepaid card account, as represented by block 325. In some embodiments, the customer engages in the transaction well after (e.g., a month after) the prepaid card account accumulates the rewards referred to in block 320. Although not shown in FIG. 3, in some embodiments, the customer is authenticated at the transaction machine. For example, in some embodiments, the transaction machine (and/or the apparatus having the process flow 300) authenticates the customer based at least partially on a PIN, username, password, account number, and/or other credential the customer presents to the transaction machine (and/or apparatus). In some embodiments, the prepaid card account is associated with a PIN unique to the prepaid card account and/or to the prepaid card account holder (e.g., the customer), such that the prepaid card and/or the prepaid card account cannot be used to engage in a transaction unless the PIN is provided to the transaction machine (and/or to the apparatus having the process flow 300).

Sometime during the transaction, the transaction machine sends an authorization request associated with the transaction to the apparatus having the process flow 300, as represented by block 330. After receiving the authorization request, the apparatus having the process flow 300 is configured to determine whether the transaction amount exceeds the balance of the prepaid card account, as represented by block 335. If yes, then the apparatus declines the transaction (e.g., because the prepaid card account cannot be overdrawn), as represented by block 340. However, if the apparatus determines that the transaction amount does not exceed the balance of the prepaid card account, the apparatus is configured to authorize the transaction, as represented by block 345. Thereafter, the transaction is completed (e.g., purchase transaction is completed, ATM withdrawal transaction dispenses cash, etc.), and the customer leaves the transaction machine, as represented by block 350.

In addition to authorizing the transaction, the apparatus having the process flow 300 decreases the balance of the prepaid card account by the transaction amount, as represented by block 355. Thereafter, the apparatus attributes rewards to the prepaid card account based at least partially on decreasing the balance of the prepaid card account, as represented by block 360. In other words, the apparatus attributes rewards based at least partially on the customer engaging in the transaction and/or spending funds previously loaded onto the prepaid card account. Thus, in this example embodiment, the prepaid card account accumulates rewards both by spending funds from the prepaid card account and by loading (and by reloading, as represented by block 375) funds onto the prepaid card account. It will be understood that this ability to accumulate rewards encourages the customer to use and reuse the prepaid card account (instead of, for example, the customer's other accounts) to engage in transactions. Again, it will also be understood that, in some embodiments, the rewards are not attributed to the prepaid card account immediately after the transaction, but rather, are attributed to the account at, for example, the end of a statement cycle.

Sometime after the transaction is completed, the customer transfers, and the apparatus receives, second funds for reloading the prepaid card account, as represented by block 365. Thereafter, the apparatus increases the balance of the prepaid card account by the amount of the second funds, as represented by block 370. In addition, as represented by block 375, the apparatus attributes rewards to the prepaid card account based at least partially on increasing the balance of the prepaid card account by the amount of the second funds. In other words, the apparatus attributes rewards based at least partially on the customer reloading funds onto the prepaid card account. As mentioned previously, it will be understood that, in some embodiments, these rewards are not attributed to the prepaid card account immediately after the reloading, but rather are attributed to the account at, for example, the end of a statement cycle.

Sometime after the prepaid card account has been reloaded and/or has accumulated the rewards referred to in block 375, the apparatus is configured to present a user interface to the customer, where the user interface enables and/or prompts the customer to redeem his rewards for one or more products, as represented by block 380. In some embodiments, the apparatus presents the user interface to the customer based at least partially on the customer submitting a request for redemption information. For example, in some embodiments, the customer accesses an online banking account associated with the prepaid card account and selects a link or button associated with redeeming rewards (e.g., a “Redeem Rewards” digital, selectable button) and/or viewing information associated with one or more products. As another example, in some embodiments, the apparatus presents a graphical user interface (GUI) to the customer, where the GUI presents a plurality of products from which the customer can select, including, for example, clothing, electronics, tickets, cash, gift cards, statement/account credits, and/or the like. After the customer is presented with the user interface, the apparatus receives information associated with the customer selecting a product to receive in exchange for redeeming one or more of the customer's rewards, and the apparatus provides (or instructs another fulfillment apparatus to provide) the selected product to the customer, as represented by block 385.

Of course, it will be understood that the embodiment illustrated in FIG. 3 is merely exemplary and that other embodiments may vary without departing from the scope and spirit of the present invention. In addition, the apparatus having the process flow 300 can be configured to perform one or more portions of the process flow 300 in real time, in substantially real time, and/or at one or more predetermined times. The apparatus having the process flow 300 may be configured to perform any of the portions of the process flow 300 represented by blocks 305-385 upon or after one or more triggering events (which, in some embodiments, is the performance of one or more of the other portions of the process flow 300). In addition, in some embodiments, the apparatus having the process flow 300 (and/or a user thereof) is configured to perform one or more portions (or combinations of portions) of the process flow 300, from start to finish, within moments, seconds, and/or minutes (e.g., within approximately 1-15 minutes, etc.).

Referring now to FIG. 4, a system 400 is illustrated for providing one or more prepaid cards, prepaid card accounts, and/or attributing rewards to prepaid card accounts, in accordance with an embodiment of the present invention. As shown, the system 400 includes a network 410, a user interface apparatus 420, an account apparatus 430, and a transaction machine 440. FIG. 4 also shows an account holder 402, a prepaid card 407, an account profile 404, and redemption datastores 406. It will be understood that, in this example embodiment, the prepaid card 407 is associated with a prepaid card account that is held by the account holder 402 and maintained by a bank. The account profile 404 is associated with the prepaid card account and is stored in the account datastore 438 of the account apparatus 430. Also as shown, the account profile 404 stores prepaid card account information 404A and rewards information associated with the prepaid card account (e.g., rewards balances, terms and conditions of earning rewards, redemption history, etc.). Further, the redemption datastores 406 are stored in the account datastore 438 and include the merchants datastore 406A and the products datastore 406B. As shown, in this example embodiment, the holder 402 has access to the user interface apparatus 420 (e.g., personal computer, mobile phone, PDA, banking center kiosk, ATM, etc.), the transaction machine 440 (e.g., POS device, ATM, personal computer, mobile phone, etc.), and the prepaid card 407. In addition, in this example embodiment, the user interface apparatus 420 is maintained by the account holder 402, the transaction machine 440 is maintained by a merchant, and the account apparatus 430 is maintained by the same bank that maintains the holder's 402 prepaid card account.

As shown in FIG. 4, the user interface apparatus 420, the account apparatus 430, and the transaction machine 440 are each operatively and selectively connected to the network 410, which may include one or more separate networks. The network 410 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. It will also be understood that the network 410 may be secure and/or unsecure and may also include wireless and/or wireline technology.

The user interface apparatus 420 may include any computerized apparatus that can be configured to perform any one or more of the functions of the user interface apparatus 420 described and/or contemplated herein. It will also be understood that the user interface apparatus 420 can include and/or be embodied as any apparatus described and/or contemplated herein. It will further be understood that the user interface apparatus 420 can initiate, perform, complete, and/or otherwise facilitate any transaction described and/or contemplated herein as being initiated, performed, and/or otherwise facilitated by an apparatus. For example, in some embodiments, the user interface apparatus 420 includes and/or is embodied as a personal computer, PDA, mobile phone, gaming device, ATM, banking center kiosk, computer system, front end system, network device, and/or the like. As another example, in some embodiments, the user interface apparatus 420 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); selecting one or more budget categories, spending limits, spending thresholds, and/or alert preferences; loading and/or reloading funds onto prepaid card accounts; accessing the Internet; and/or the like.

In some embodiments, the user interface apparatus 420 (and/or one or more other portions of the system 400) requires its users to authenticate themselves to the user interface apparatus 420 before the user interface apparatus 420 will initiate, perform, complete, and/or facilitate a transaction. For example, in some embodiments, the user interface apparatus 420 (and/or the interface application 427) is configured to authenticate a user based at least partially on an ATM/debit/credit card, loyalty/rewards/club card, smart card, token (e.g., USB token, etc.), username/password, personal identification number (PIN), biometric information, and/or one or more other credentials that the user presents to the user interface apparatus 420. In some embodiments, the one or more credentials may be associated with the prepaid card and/or prepaid card account (e.g., a PIN associated with the prepaid card and/or prepaid card account). Additionally or alternatively, in some embodiments, the user interface apparatus 420 is configured to authenticate a user by using one-, two-, or multi-factor authentication. For example, in some embodiments, where the user interface apparatus 420 is embodied as an ATM, the user interface apparatus 420 may require two-factor authentication, such that the holder 402 must provide a valid prepaid card and enter the correct PIN associated with the prepaid card in order to authenticate the holder 402 to the user interface apparatus 420.

As illustrated in FIG. 4, in accordance with some embodiments of the present invention, the user interface apparatus 420 includes a communication interface 422, a processor 424, a memory 426 having an interface application 427 stored therein, and a user interface 429. In such embodiments, the processor 424 is operatively and selectively connected to the communication interface 422, the user interface 429, and the memory 426.

Each communication interface described herein, including the communication interface 422, generally includes hardware, and, in some instances, software, that enables a portion of the system 400, such as the user interface apparatus 420, to send, receive, and/or otherwise communicate information to and/or from the communication interface of one or more other portions of the system 400. For example, the communication interface 422 of the user interface apparatus 420 may include a modem, network interface controller (NIC), near field communication (NFC) interface, network adapter, network interface card, and/or some other electronic communication device that operatively connects the user interface apparatus 420 to another portion of the system 400, such as, for example, the account apparatus 430.

Each processor described herein, including the processor 424, generally includes circuitry for implementing the audio, visual, and/or logic functions of that portion of the system 400. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the interface application 427 of the memory 426 of the user interface apparatus 420.

Each memory device described herein, including the memory 426 for storing the interface application 427 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 4, the memory 426 includes the interface application 427. It will be understood that the interface application 427 can be operable (e.g., usable, executable, etc.) to initiate, perform, complete, and/or facilitate one or more portions of any embodiment described and/or contemplated herein, such as, for example, one or more portions of the process flows 100, 200, and/or 300 described herein and/or one or more portions of the process flow described in connection with FIG. 5. For example, in some embodiments, the interface application 427 is operable to present a GUI (e.g., browser screen, web page) to the holder 402 via the user interface 429, where the GUI enables and/or prompts the holder to open a prepaid card account, redeem rewards, view one or more products to receive in exchange for redeeming rewards, and/or load and/or reload the prepaid card account with funds. As another example, in some embodiments, the interface application 427 is operable to access an electronic banking account (e.g., online banking account, mobile banking account, etc.) associated with the prepaid card account and/or to enable a prepaid card account holder to view information associated with the prepaid card account (e.g., transaction history, balance amount, etc.).

In some embodiments, where the user interface apparatus 420 includes and/or is embodied as an ATM, the interface application 427 is configured to execute on the ATM in order to initiate, perform, complete, and/or facilitate, for example, one or more redemption transactions, cash withdrawals, deposits, and/or the like. In other embodiments, where the user interface apparatus 420 includes and/or is embodied as a mobile phone, the interface application 427 is configured to execute on the mobile phone in order to access a mobile banking account and/or initiate, perform, complete, and/or facilitate, for example, one or more redemption transactions, funds transfers, etc. In still other embodiments, where the user interface apparatus 420 includes and/or is embodied as a personal computer, the interface application 427 is configured to execute on the personal computer, and, in some embodiments, the interface application 427 is embodied as a web browser (i.e., for navigating the Internet, accessing an online banking account, etc.) that is operable to initiate, perform, complete, and/or otherwise facilitate one or more redemption transactions, as well as other financial and/or non-financial transactions.

In some embodiments, the interface application 427 is operable to enable the holder 402 and/or user interface apparatus 420 to communicate with one or more other portions of the system 400, and/or vice versa. In some embodiments, the interface application 427 includes one or more computer-executable program code portions for causing and/or instructing the processor 424 to perform one or more of the functions of the interface application 427 and/or user interface apparatus 420 described and/or contemplated herein. In some embodiments, the interface application 427 includes and/or uses one or more network and/or system communication protocols.

As shown in FIG. 4, the user interface apparatus 420 also includes the user interface 429. It will be understood that the user interface 429 (and any other user interface described and/or contemplated herein) can include and/or be embodied as one or more user interfaces. It will also be understood that, in some embodiments, the user interface 429 includes one or more user output devices for presenting information and/or one or more items to the transaction machine user (e.g., the holder 402, etc.), such as, for example, one or more displays, speakers, receipt printers, dispensers (e.g., cash dispensers, ticket dispensers, merchandise dispensers, etc.), and/or the like. In some embodiments, the user interface 429 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the transaction machine user (e.g., the holder 402, etc.). In some embodiments, the user interface 429 and/or the user interface apparatus 420 includes one or more vaults, security sensors, locks, and/or anything else typically included in and/or near a transaction machine.

FIG. 4 also illustrates an account apparatus 430, in accordance with an embodiment of the present invention. The account apparatus 430 may include any computerized apparatus that can be configured to perform any one or more of the functions of the account apparatus 430 described and/or contemplated herein. It will also be understood that the account apparatus 430 can include and/or be embodied as any apparatus described and/or contemplated herein. It will further be understood that the account apparatus 430 can initiate, perform, complete, and/or otherwise facilitate any transaction described and/or contemplated herein as being initiated, performed, and/or otherwise facilitated by an apparatus. In some embodiments, the account apparatus 430 includes and/or is embodied as one or more servers, engines, mainframes, computer systems, personal computers, ATMs, network devices, front end systems, back end systems, and/or the like. In some embodiments, such as the one illustrated in FIG. 4, the account apparatus 430 includes a communication interface 432, a processor 434, and a memory 436, which includes an account application 437 and an account datastore 438 stored therein. As shown, the communication interface 432 is operatively and selectively connected to the processor 434, which is operatively and selectively connected to the memory 436.

The account application 437 can be operable (e.g., usable, executable, etc.) to initiate, perform, complete, and/or facilitate any one or more portions of the process flows 100, 200, and/or 300 described herein and/or one or more portions of the process flow described in connection with FIG. 5. For example, in some embodiments, the account application 437 is operable to receive transaction information associated with a transaction. As another example, in some embodiments, the account application 437 is operable to determine, based at least partially on the transaction information, that the transaction involves a prepaid card account (e.g., the prepaid card account held by the holder 402 and associated with the prepaid card 407). As still another example, in some embodiments, the account application 437 is operable to determine that the prepaid card account has a balance and/or whether a transaction amount exceeds that balance. Still further, in some embodiments, the account application 437 is operable to decline and/or authorize a transaction. Additionally or alternatively, in some embodiments, the account application 437 is operable to determine whether a transaction has been completed. Still further, in some embodiments, the account application 437 is operable to attribute rewards to a prepaid card account based at least partially on the prepaid card account engaging in transaction and/or based at least partially on the prepaid card account being loaded and/or reloaded with funds. In some embodiments, the account application 437 is operable to receive funds (e.g., from a holder) for loading and/or reloading a prepaid card account, and in some embodiments, the account application 437 is operable to load and/or reload a prepaid card account.

Further, in some embodiments, the account application 437 is operable to present a GUI (e.g., browser screen, web page) to the holder 402 via the user interface 429 of the user interface apparatus 420, where the GUI enables and/or prompts the holder to open a prepaid card account, redeem rewards, view one or more products to receive in exchange for redeeming rewards, and/or load and/or reload the prepaid card account with funds. As another example, in some embodiments, the account application 427 is operable to access an electronic banking account (e.g., online banking account, mobile banking account, etc.) associated with the prepaid card account and/or to enable a prepaid card account holder to view information associated with the prepaid card account (e.g., transaction history, balance amount, etc.).

In some embodiments, the account application 437 is operable to enable the account apparatus 430 to communicate with one or more other portions of the system 400, such as, for example, the account datastore 438, the transaction machine 440, and/or the user interface apparatus 420, and/or vice versa. In addition, in some embodiments, the account application 437 is operable to initiate, perform, complete, and/or otherwise facilitate one or more redemption transactions, as well as one or more other financial and/or non-financial transactions. In some embodiments, the account application 437 includes one or more computer-executable program code portions for causing and/or instructing the processor 434 to perform one or more of the functions of the account application 437 and/or the account apparatus 430 that are described and/or contemplated herein. In some embodiments, the account application 437 includes and/or uses one or more network and/or system communication protocols.

In addition to the account application 437, the memory 436 also includes the account datastore 438. It will be understood that the account datastore 438 can be configured to store any type and/or amount of information. As shown, the account datastore 438 stores the account profile 404, which includes prepaid card account information 404A and rewards information 404B. The account information 404A may include any information associated with the prepaid card account held by the holder 402, including, for example, transaction information associated with one or more transactions involving the prepaid card account (e.g., date/time, description, transaction amount, merchant category codes, etc.), information associated with one or more account holders (e.g., holder 402), information associated with one or more account preferences, billing information, and/or the like. The rewards information 404B may include any information associated with the rewards accumulated by the prepaid card account (e.g., the rewards balance associated with the prepaid card account), the redemption history of the prepaid card account (e.g., a record of products the holder previously received in exchange for redeeming rewards), the holder's wish list of products, the terms and conditions associated with the prepaid card account and/or accumulating rewards, and/or the like.

In addition to the account profile 404, the account datastore 438 includes the redemption datastores 406, which includes the merchants datastore 406A and the products datastore 406B. The merchants datastore 406A may include any information associated with one or more merchants that can be associated with one or more prepaid card accounts, one or more rewards, and/or one or more products that can be received in exchange for redeeming one or more rewards. For example, in some embodiments, the merchants datastore 406A lists the names and brands of all of the merchants (e.g., Ducks Unlimited®, Make-A-Wish®, Bass Pro Shops®, etc.) that have partnered with the bank that maintains the prepaid card account. The products datastore 406B may include any information associated with one or more products that can be received in exchange for redeeming one or more rewards. For example, in some embodiments, the products datastore 406B lists the images, descriptions, costs, and/or availability of the one or more products. In some embodiments, one or more of the products stored in the products datastore 406B are branded by, or sold by, a merchant listed in the merchant datastore 406A. For example, in some embodiments, the products datastore 406B stores information associated with a plurality of Bass Pro Shops®-branded products (e.g., mugs, t-shirts, gift cards, fishing poles, etc.), a plurality of Ducks Unlimited®-branded products, a plurality of Make-A-Wish®-branded products, and/or the like. In some embodiments, the one or more products listed in the products datastore 406B can be filtered to retrieve one or more products associated with one or more particular, predetermined merchants.

In addition to the account profile 404 and the redemption datastores 406, the account datastore 438 may include information associated with one or more account holders (i.e., other than the holder 402), account profiles (i.e., other than the account profile 404), financial accounts (i.e., other than the prepaid card account held by the holder 402), electronic banking accounts (e.g., online banking accounts, mobile banking accounts, text banking accounts, etc.), user interface apparatuses, and/or the like. Also, the account datastore 438 may include any one or more storage devices, including, but not limited to, datastores, databases, and/or any of the other storage devices typically associated with a computer system. It will also be understood that these datastores may store information in any known way, such as, for example, by using one or more computer codes and/or languages, alphanumeric character strings, data sets, figures, tables, charts, links, documents, and/or the like. Further, in some embodiments, the account datastore 438 includes information associated with one or more applications, such as, for example, the account application 437 and/or the interface application 427. In some embodiments, the account datastore 438 provides a real-time or near real-time representation of the information stored therein, so that, for example, when the processor 434 accesses the account datastore 438, the information stored therein is current or nearly current. Although not shown, in some embodiments, the user interface apparatus 420 and/or the transaction machine 450 may each include a datastore that is configured to store information associated with those respective apparatuses. It will be understood that these datastores can store information in any known way, can include information associated with anything shown in FIG. 4, and/or can be configured similar to the account datastore 438.

The embodiment illustrated in FIG. 4 is exemplary and other embodiments may vary. For example, in some embodiments, some or all of the portions of the system 400 are combined into a single portion. Specifically, in some embodiments, the user interface apparatus 420 and the transaction machine 440 are combined into a single apparatus that is configured to perform all of the same functions of those separate portions as described and/or contemplated herein. Likewise, in some embodiments, some or all of the portions of the system 400 are separated into two or more distinct portions. In addition, the various portions of the system 400 may be maintained by the same or separate parties.

The system 400 and/or one or more portions of the system 400 may include and/or implement any embodiment of the present invention described and/or contemplated herein. For example, in some embodiments, the system 400 (and/or one or more portions of the system 400) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow 300 described and/or contemplated herein in connection with FIG. 3, and/or any one or more embodiments of the process flow described and/or contemplated herein in connection with FIG. 5.

As a specific example, in accordance with an embodiment of the present invention, the account apparatus 430 is configured to: (a) receive, from the holder 402 of the prepaid card account, funds for loading or reloading the prepaid card account, as represented by block 210 in FIG. 2; (b) load or reload the prepaid card account using the funds provided by the holder 402, as represented by block 220; and (c) attribute rewards to the prepaid card account based at least partially on loading or reloading the prepaid card account, as represented by block 230. In accordance with some embodiments, the user interface apparatus 420, the account apparatus 430, and/or the transaction machine 440 are each configured to send and/or receive one or more instructions to and/or from each other, such that an instruction sent, for example, from the user interface apparatus 420 to the account apparatus 430 (and/or vice versa) can trigger the account apparatus 420 (and/or vice versa) to perform one or more portions of any one or more of the embodiments described and/or contemplated herein.

Referring now to FIG. 5, a mixed block and flow diagram of a system 500 is provided for attributing rewards to a prepaid debit card account, in accordance with an exemplary embodiment of the present invention. It will be understood that the system 500 illustrated in FIG. 5 represents an example embodiment of the process flow 100 described in connection with FIG. 1 and/or an example embodiment of the process flow 200 described in connection with FIG. 2. As shown, the system 500 includes a kiosk 501 (e.g., the transaction machine 440), a prepaid card account server 503 (e.g., the account apparatus 430), and a mobile phone 505 (e.g., the user interface apparatus 420). The kiosk 501, the prepaid card account server 503, and the mobile phone 505 may each include a communication interface, a user interface, a processor, a memory, an application, and/or a datastore, and those components may be operatively connected to each other.

In accordance with some embodiments, the kiosk 501 and the mobile phone 505 are operatively and selectively connected to the prepaid card account server 503 via one or more networks. For example, in some embodiments, the kiosk 501 is operatively connected to the prepaid card account server 503 via a payment network, and the mobile phone 505 is operatively connected to the prepaid card account server 503 via a telephone network. In addition, the kiosk 501 and the mobile phone 505 are both accessible to the customer referred to in block 502. In this example embodiment, the kiosk 501 is maintained by a train company (e.g., a merchant), the prepaid card account server 503 is maintained by the customer's bank, and the mobile phone 505 is maintained by the customer. Also in this example embodiment, the customer is a holder of the prepaid debit card account (e.g., the holder 402) mentioned below, the bank maintains the prepaid debit card account, and the prepaid debit card account is associated with a prepaid debit card (e.g., the prepaid card 407). Further, it will be understood that the customer has already opened the prepaid debit card account and loaded the prepaid debit card account with funds before any portion of the process flow illustrated in FIG. 5 is performed.

As represented by block 502, the customer reloads his prepaid debit card account with $50 in funds at the kiosk 501. As a result, the prepaid account server 503 attributes 1% of the reloaded funds to the prepaid debit card account as rewards for reloading the account, as represented by block 504. As a result, as represented by block 506, the server 503 increases the customer's rewards balance (e.g., the rewards balance associated with the prepaid debit card account) by $0.50, which is 1% of the $50 loaded funds. Sometime after reloading the account, the customer swipes the prepaid debit card through the kiosk 501 to initiate a $75 rail pass transaction (e.g., the customer purchases a rail pass), as represented by block 508. Thereafter, the server 503 receives transaction information associated with the rail pass transaction, as represented by block 510. The server 503 then determines that the prepaid debit card account has a $250 balance (i.e., the reloading referred to in block 502 increased the balance from $200 to $250), as represented by block 512. Then, as represented by block 514, the server 503 determines that the balance of the prepaid debit card account exceeds the transaction amount of the rail pass transaction (i.e., that the $250 balance>the $75 rail pass transaction amount). As a result of this determination, the server 503 authorizes the rail pass transaction, as represented by block 516. Thereafter, the transaction is completed at the kiosk 501 (e.g., the rail pass is dispensed from the kiosk 501), as represented by block 518.

After authorizing the transaction, the prepaid card account server 503 attributes 3% of the rail pass transaction amount to the prepaid debit card account as rewards for engaging in the rail pass transaction, as represented by block 520. Thus, it will be understood that the prepaid debit card account in this example embodiment is capable of accumulating rewards both for engaging in transactions and for loading and/or reloading the prepaid debit card account with funds. It will also be understood that, as shown in this example embodiment, the prepaid card account may accumulate more rewards for spending funds on the prepaid card account than for loading and/or reloading funds onto the prepaid card account (e.g., the customer receives 3% rewards for spending funds and 1% rewards for reloading funds). (Of course, in other embodiments, the opposite may be true.) As a result of attributing the rewards for engaging in the transaction, the server 503 increases the customer's rewards balance by $2.25, which is 3% of the $75 rail pass transaction, as represented by block 522. Although not shown, the server 503 may also be configured to decrease the balance of the prepaid debit card account from $250 to $175 as a result of the $75 rail pass transaction.

Sometime after increasing the rewards balance, the server 503 also determines that the prepaid debit card account has accumulated enough rewards to redeem for a product (e.g., clothing, electronics, cash, statement credit, gift card, etc.), as represented by block 524. Thereafter, the server 503 generates and sends an alert (e.g., text message, email, notification, phone call, etc.) to the customer's mobile phone 505, where the alert indicates that the customer has accumulated enough rewards to redeem for the product, as represented by block 526. For example, in some embodiments, where the alert is a text message and where the product is a travel gift card, the server 503 generates and sends the text message to the customer at the mobile phone 505, where the text message states “Regarding Your Prepaid Debit Card Account, You Have Now Have Enough Rewards to Redeem for a Travel Gift Card!” In some embodiments, the alert may additionally or alternatively include information associated with the rail pass transaction, such as, for example, a text message that states “Your Prepaid Debit Card Account Was Just Used to Purchase a $75 Rail Pass at the Ticketing Kiosk at South Train Station.” In response to receiving the alert, the customer may use the mobile phone 505 to log in to a mobile banking account (e.g., via a mobile banking application executing on the mobile phone 505) associated with the prepaid debit card account, as represented by block 528, and the customer may view and/or select the product for redemption, as represented by block 530. In some embodiments, the alert prompts the customer to access the mobile banking account and/or to view and/or select the product for redemption. Further, in some embodiments, the customer is required to provide a PIN associated with the prepaid debit card and/or a username/password associated with the mobile banking account before being provided access to the mobile banking account and/or being allowed to view and/or select the product for redemption. Although not shown, the customer may also reload his prepaid debit card account via the mobile banking account. For example, in some embodiments, the customer may transfer funds from his checking account (e.g., which, in some embodiments, is also accessible via the mobile banking account) to his prepaid debit card account.

Of course, the embodiment illustrated in FIG. 5 is merely exemplary and other embodiments may vary without departing from the scope and spirit of the present invention. For example, in some embodiments, one or more portions of the process flow being performed by the prepaid card account server 503 are performed instead by the kiosk 501 and/or the mobile phone 505, and/or vice versa. Also, in some embodiments, one or more of the portions of the process flow represented by blocks 502-530 are triggered by one or more triggering events, which, in some embodiments, include the performance of one or more of the other portions of the process flow represented by blocks 502-530. Also, in some embodiments, the system 500 is configured to perform the entire process flow represented by blocks 502-530, from start to finish, within moments, seconds, and/or minutes. For example, in some embodiments, the prepaid card account server 503 generates and sends the alert to the customer at the mobile phone 505, as represented by block 526, within approximately 1-45 seconds of the server 503 receiving the transaction information from the kiosk 501, as represented by block 510.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving transaction information associated with a transaction, wherein the transaction comprises a transaction amount and involves a prepaid card account;
determining that the prepaid card account comprises a balance;
determining, based at least partially on the transaction information, that the transaction amount does not exceed the balance;
authorizing the transaction based at least partially on the determining that the transaction amount does not exceed the balance;
determining that the transaction is completed; and
attributing rewards to the prepaid card account based at least partially on the determining that the transaction is completed.

2. The method of claim 1, wherein the attributing rewards comprises attributing rewards to the prepaid card account only if a predetermined spending condition is met.

3. The method of claim 1, further comprising:
loading the prepaid card account with funds provided by a holder of the prepaid card account; and
attributing second rewards to the prepaid card account based at least partially on the loading the prepaid card account.

4. The method of claim 3, wherein the attributing the second rewards comprises attributing the second rewards to the prepaid card account only if a predetermined loading condition is met.

5. The method of claim 3, wherein the loading the prepaid card account comprises receiving a direct deposit of funds into the prepaid card account, and wherein the attributing the second rewards comprises attributing the second rewards to the prepaid card account at least partially because the funds were received as a direct deposit.

6. The method of claim 3, further comprising:
reloading the prepaid card account with second funds provided by the holder, wherein the reloading occurs after the loading; and
attributing third rewards to the prepaid card account based at least partially on the reloading the prepaid card account.

7. The method of claim 1, further comprising:
presenting a user interface to a holder of the prepaid card account, wherein the user interface enables the holder to: (a) redeem the rewards for one or more products; or (b) load the prepaid card account with funds.

8. The method of claim 7, wherein the prepaid card account is associated with a merchant, and wherein the one or more products are branded by the merchant.

9. An apparatus comprising:
a communication interface configured to receive transaction information associated with a transaction, wherein the transaction comprises a transaction amount and involves a prepaid card account; and
a processor operatively connected to the communication interface and configured to:
determine that the balance of the prepaid card account is greater than the transaction amount;
authorize the transaction based at least partially on determining that the balance is greater than the transaction amount; and
attribute rewards to the prepaid card account for engaging in the transaction.

10. The apparatus of claim 9, wherein the processor attributes the rewards only if a predetermined spending condition is met.

11. The apparatus of claim 9, wherein the processor is further configured to:
load the prepaid card account with funds; and
attribute second rewards to the prepaid card account for loading the prepaid card account.

12. The apparatus of claim 10, wherein the processor attributes the second rewards only if a predetermined loading condition is met.

13. The apparatus of claim 11, wherein the processor is further configured to:
reload the prepaid card account with second funds after the processor loads the prepaid card account with the funds; and
attribute third rewards to the prepaid card account for reloading the prepaid card account.

14. The apparatus of claim 9, wherein the communication interface is further configured to present a user interface to a holder of the prepaid card account, wherein the user interface enables the holder to: (a) redeem the rewards for one or more products; and (b) load the prepaid card account with funds.

15. A computer program product comprising a non-transitory computer-readable medium, wherein the non-transitory computer-readable medium comprises one or more computer-executable program code portions that, when executed by a computer, cause the computer to:
receive transaction information associated with a transaction, wherein the transaction comprises a transaction amount and involves a prepaid card account;
determine, based at least partially on the transaction information, that the transaction amount does not exceed the balance of the prepaid card account;
authorize the transaction based at least partially on the computer determining that the transaction amount does not exceed the balance; and
attribute rewards to the prepaid card account based at least partially on the prepaid card account engaging in the transaction.

16. The computer program product of claim 15, wherein the one or more computer-executable program code portions, when executed by the computer, cause the computer to:
load the prepaid card account with funds; and
attribute second rewards to the prepaid card account based at least partially on the computer loading the prepaid card account.

17. The computer program product of claim 15, wherein the one or more computer-executable program code portions, when executed by the computer, cause the computer to:
reload the prepaid card account with second funds after the computer loads the prepaid card account with the funds; and
attribute third rewards to the prepaid card account based at least partially on the computer reloading the prepaid card account.

18. The computer program product of claim 15, wherein the one or more computer-executable program code portions, when executed by the computer, cause the computer to:
present a user interface to a holder of the prepaid card account, wherein the user interface enables the holder to load the prepaid card account with funds.

19. A method comprising:
receiving funds from a holder of a prepaid card account for loading the prepaid card account;
increasing, using a processor, a balance of the prepaid card account based at least partially on the receiving the funds; and
attributing, using a processor, rewards to the prepaid card account based at least partially on the holder loading the prepaid card account.

20. The method of claim 19, wherein the increasing the balance of the prepaid card account comprises increasing the balance of the prepaid card account by an amount equal to the amount of the funds.

21. The method of claim 19, further comprising:
receiving second funds from the holder for reloading the prepaid card account;
increasing the balance of the prepaid card account based at least partially on the receiving the second funds; and
attributing second rewards to the prepaid card account based at least partially on the holder reloading the prepaid card account.

22. The method of claim 19, wherein the receiving the funds comprises receiving a direct deposit of funds directly into the prepaid card account, and wherein the attributing the rewards comprises attributing the rewards at least partially because the funds were received as a direct deposit.

23. The method of claim 19, wherein the attributing the rewards comprises attributing the rewards to the prepaid card account only if a predetermined loading condition is met.

24. The method of claim 19, further comprising:
presenting a user interface to the holder, wherein the user interface enables the holder to load the prepaid card account with funds, and
wherein the receiving the funds is based at least partially on the holder using the user interface to load the prepaid card account.
